(19) United States
(12) Patent Application Publication
(10) Pub. No.: US 2006/0119157 A1
(43) Pub. Date: Jun. 8, 2006

(54) Fold-down vehicle seat

(75) Inventors: Yoshikazu Itoh, Tokyo (JP); Masatoshi Takahara, Akishima-shi (JP)

Correspondence Address: BROWDY AND NEIMARK, P.L.L.C.;624 NINTH STREET, NW, SUITE 300, WASHINGTON, DC, 20001-5303, US

(73) Assignee: Tachi-S Co. Ltd., Akishima-shi (JP)

(21) Appl. No.: 10/995,483

(22) Filed: Nov. 24, 2004

(51) Int. Cl. B60N 2/48

(52) U.S. Cl. 297/378.1

(57) ABSTRACT

Fold-down vehicle seat having a foldable seat cushion and a seat back foldable on to the seat cushion. In this seat, a link element is movably connected between the forward end portion of the seat cushion and a vehicle floor so as to be movable upwardly and downwardly. Also, a slide element is operatively provided between the backward end portion of the seat cushion and the vehicle floor, thereby allowing the seat cushion to be slidingly movable forwardly and backwardly of the seat. Thus, the seat cushion is foldable down to a folded-down storage position in the vehicle floor, with the seat back being foldable onto the seat cushion. A lock mechanism is provided between the slide element and seat cushion, so that the seat can be locked to the folded-down storage position and also adjustably locked to a desired seating height, in conjunction with the link and slide elements.

### BACKGROUND OF THE INVENTION

1. Field of the Invention

The present invention relates to a folding or fold-down seat for use in a vehicle, which is foldable down into a folded state for storage in a given seat location in the vehicle.

2. Description of Prior Art

There have been known various kinds of fold-down vehicle seats. Among them, as far as the present invention is concerned, conventional fold-down vehicle seats can be classified into two types. Namely, one type of the conventional fold-down vehicle seats is of such a structure that two links are pivotally connected at their respective two ends between the seat cushion and a vehicle floor in the so-called four-point link articulation manner, thereby allowing the seat back to be foldable forwardly at the position where the seat is located and then a seat cushion is foldable downwardly to a storage position at that position, so that the seat cushion may be stably folded down via the links onto the floor.

But, in such four-point link articulation type of fold-down seat, a large amount of force is required on the users side to raise the folded seat cushion to a normal use position, and further, folding and unfolding the seat is troublesome and uneasy due to the complicated and relatively heavy structure.

On the other hand, there is another kind of fold-down vehicle seat having the structure wherein both seat cushion and seat back are movable on a vehicle floor in forward and backward directions, and the seat back is foldable forwardly onto the seat back which is in turn foldable downwardly to a storage area. This fold-down seat is for example disclosed from the Japanese Laid-Open Patent Publication No. 55-160626, but, as similar to the previously stated fold-down seat, its structure is complicated and relatively heavy and therefore, folding and unfolding of the seat requiems a large amount of force and labor on the user's side.

### SUMMARY OF THE INVENTION

In view of the above-stated drawbacks, it is a purpose of the present invention to provide an improved fold-down seat which can be easily folded and unfolded by a small handling force of user.

In order to achieve such purpose, the fold-down seat in accordance with the present invention is basically comprised of:
a seat cushion having an upper seating side and a lower side opposite to the upper seating side, wherein the lower side has a forward end portion defined forwardly of the fold-down vehicle seat and a backward end portion defined backwardly of the fold-down vehicle seat;
a seat back rotatably connected with the seat cushion so as to be foldable down on to the upper seating side of the seat cushion;
a link means movaby connected between the forward end portion of the bottom side of the seat cushion and the vehicle floor in such a manner as to be movable forwardly and backwardly of the fold-down vehicle seat; and
a slide means operatively provided between the backward end portion of the bottom side of the seat cushion and the vehicle floor, the slide means allowing the seat cushion to be slidingly movable forwardly and backwardly of the fold-down vehicle seat.

Preferably, a lock means may be provided, which is operable to a locking direction so as to place the fold-down vehicle seat in a locked state to a given position and also operable to an unlocking direction so as to place the fold-down vehicle seat in an unlocked state from the given position. The lock means includes a female engagement means and a male engagement means movable for engagement in and disengagement from the female engagement means, wherein the female engagement means is defined in the slide means, while the male engagement is provided to the lower side of the seat cushion, such that locking operation of the lock means to the locking direction causes engagement of the male engagement means in the female engagement means, thereby placing the fold-down vehicle seat in the locked state, while by contrast, unlocking operation of the lock means to the unlocking direction causes disengagement of the male engagement means from the female engagement means, thereby placing the fold-down vehicle seat in the unlocked state.

The female engagement means may comprise a plurality of lock holes formed in the slide means and the male engagement means comprises a lock rod movably provided to the lower side of the seat cushion so as to be engageable in and disengageable from a selected one of the plurality of lock holes.

Other various features and advantages will become apparent from reading of the descriptions hereinafter, with reference to the annexed drawings.

### BRIEF DESCRIPTION OF THE DRAWINGS

FIG. 1 is a schematic side elevational view of a fold-down vehicle seat in accordance with the present invention, which shows a normal use position of the seat;

FIG. 2 is a schematic side elevational view of the fold-down vehicle seat, which shows a folded down state of the seat;

FIG. 3 is a fragmentary sectional view showing a locked state of a lock mechanism provided in the seat;

FIG. 4 is a diagram for explanatorily showing the operation of lock mechanism and height adjustment of the seat;

FIG. 5 is a fragmentary sectional view showing an unlocked sate of the lock mechanism provided in the seat; and

FIG. 6 is a diagram for explanatorily showing how to unfold and return the seat to a normal use state.

### DETAILED DESCRIPTION OF PREFERRED EMBODIMENT OF THE INVENTION

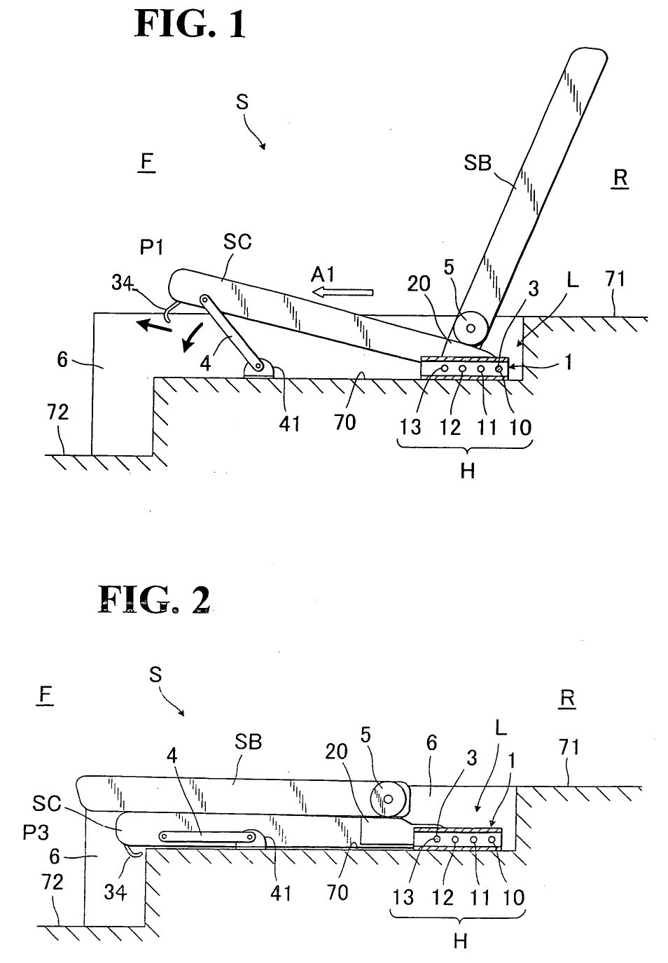

Referring to FIGS. 1 through 6, there is illustrated one exemplary embodiment of fold-down vehicle seat, as generally designated by (S), in accordance with the present invention.

The illustrated fold-down seat (S) itself is a bench seat or a second seat provided in the rearward cabin section of a vehicle, by way of example.

As shown, a floor on which the seat (S) is mounted is formed to have a cargo-loading floor region (71), a seat mount floor region (70) and a footrest floor region (72). The cargo-loading floor region (71) is a typical load-carrying platform area defined in the backward cabin section of a vehicle (not shown). The seat mount floor region (70) is a floor area where the present fold-down seat (S) is movably provided, which is lower than the cargo-loading floor region (71). The footrest floor region (72) is a floor area defined lower than the seat mount floor region (70) for allowing an occupant on the seat (S) to rest his or her feet thereon. Designation (6) stands for a vertical lateral wall extending downwardly from the cargo-loading floor region (71) to both of the seat mount and footrest floor regions (70) (72). While not shown, defined at a side opposite to that vertical lateral wall (6) is another same vertical lateral wall, so that, as any person skilled in the art will notice, there are a pair of vertical lateral walls (6) which substantially define a seat area where the seat (S) is located and the foregoing seat mount floor region (70) and footrest floor region (72) are formed.

In accordance with the present invention, the fold-down seat (S) basically comprises a seat back (SB), a seat cushion (SC), a link member (4), a lock mechanism (L) and a slide means (1).

It is noted that, hereinafter, the wording, “forward” or “forwardly”, shall refer to a direction towards a forward side (F) of the seat (S), whereas, the wording, “backward” or “forwardly”, refer to a direction towards a backward side (R) of the seat (S).

Specifically, the seat back (SB) is at the lower end portion thereof rotatably connected with a backward end of the seat cushion (SC) via a reclining device (5), so that the seat back (SB) may be folded forwardly onto the seat cushion (SC). The seat cushion (SC), at the backward end portion thereof, has a connection with the lower end portion of seat back (SB) via the reclining device (5), while being at the forward end thereof movably connected with the upper end of the link member (4). In this regard, the lower end of the link member (4) is pivotally connected with a support bracket (41) fixed on the seat mount floor region (70). Hence, as shown in FIG. 1 for example, the forward end portion of the seat cushion (SC) is supported at a normal seating height (at P1) by that link member (4).

Generically stated, the lock mechanism (L) may be comprised of: a female lock engagement means generally designated by (H); and a male lock engagement means (at 3) operable for engagement with and disengagement from the female lock engagement means (H).

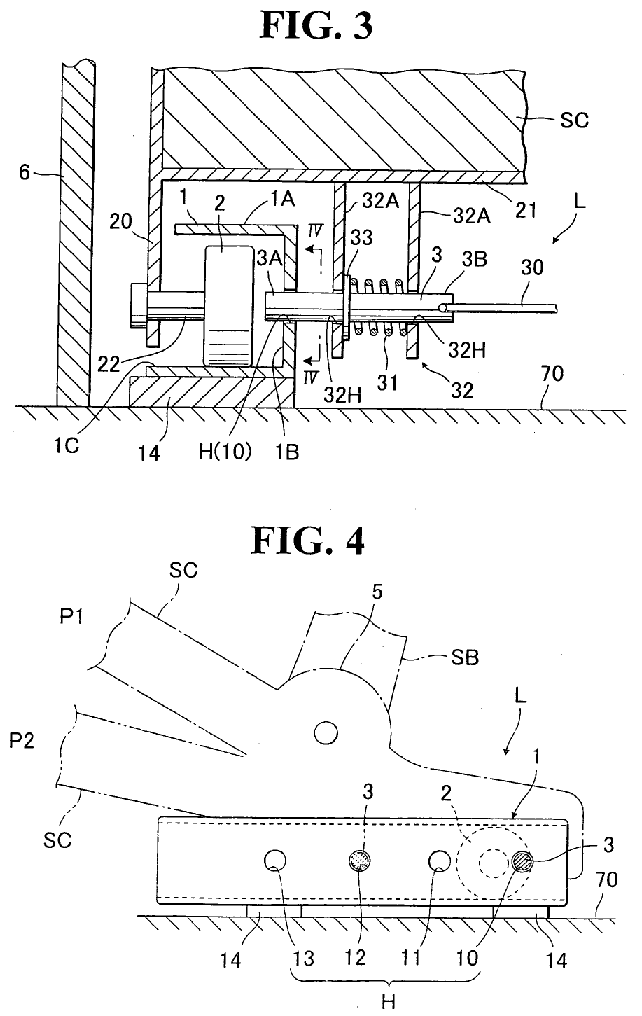

On the other hand, the slide means may comprise: a slide rail (1) and a guide roller (2). As best shown in FIG. 3, the slide rail (1) may be formed to have a channel cross-section comprising an upper horizontal wall (1A), a lower horizontal wall (1C) which is fixedly connected via a support member (14) to the seat mount floor region (70), and a vertical wall (1B) defined between the upper and lower horizontal walls (1A) (1C). The guide roller (2) is at its shaft (22) rotatably connected with the bracket (20) and rollably disposed in a guide passage defined by the upper, lower and vertical walls (1A) (1C) (1B) of the slide rail (1). Hence, the seat cushion (SC) is not only rotatable vertically about the central axis (at 22) of the roller (2), but also movable via the guide roller (22) and slide rail (1) in the forward and backward directions (at F and R).

The female lock engagement means (H) may comprise a plurality of lock holes formed in the foregoing vertical wall (1B) of the slide rail (1) in the longitudinal direction of that particular slide rail (1). In this regard, as shown for instance, the plurality of lock holes may be: a first lock hole (10), a second lock hole (11), a third lock hole (12), and a fourth lock hole (13), all of which are disposed in order from the backward end to the forward end of the slide rail (1).

The male lock engagement means may comprise a lock rod (3) which is movably supported by a connecting bracket (32) fixed to the bottom side (21) of the seat cushion (SC), such that the lock rod (3) extends on a horizontal line and concentric with each of the lock holes (H), as shown in FIG. 3. Specifically, the lock rod (3) is slidably received in two through-holes (32H) (32H) formed in the respective two spaced-apart vertical walls (32A) (32A) of the connecting bracket (32), and has a flange (33) integrally and radially formed thereabout, the flange (33) being large in diameter than the holes (32H).

In the lock mechanism (L), a biasing spring (31) is interposed between the two vertical walls (32A) of the connecting bracket (3) so as to give an outward biasing force to the flange (33), thereby normally biasing the lock rod (3) in a direction toward the lock holes (H) formed in the vertical wall (1B). Thus, normally, as can be seen in FIG. 3, one end portion (3A) of the lock rod (3) is biased to engagement in a selected one of the lock holes (H), thereby locking the seat (S) in a given position in the forward and backward directions. Further, a wire or a wire cable (30) is coupled with another end portion (3B) of the lock rod (3) and also operatively connected with a grip element (34) (e.g. a strap or other suitable element to which a user can grasp with his or her hand) which is movably provided to the forward end portion of the seat cushion (SC). With this arrangement, when the grip element (34) is drawn by the hand of user forwardly, the cable wire (30) is in turn drawn, which causes the lock rod (3) to disengage from one of the lock holes (at H), overcoming the biasing force of the spring (31).

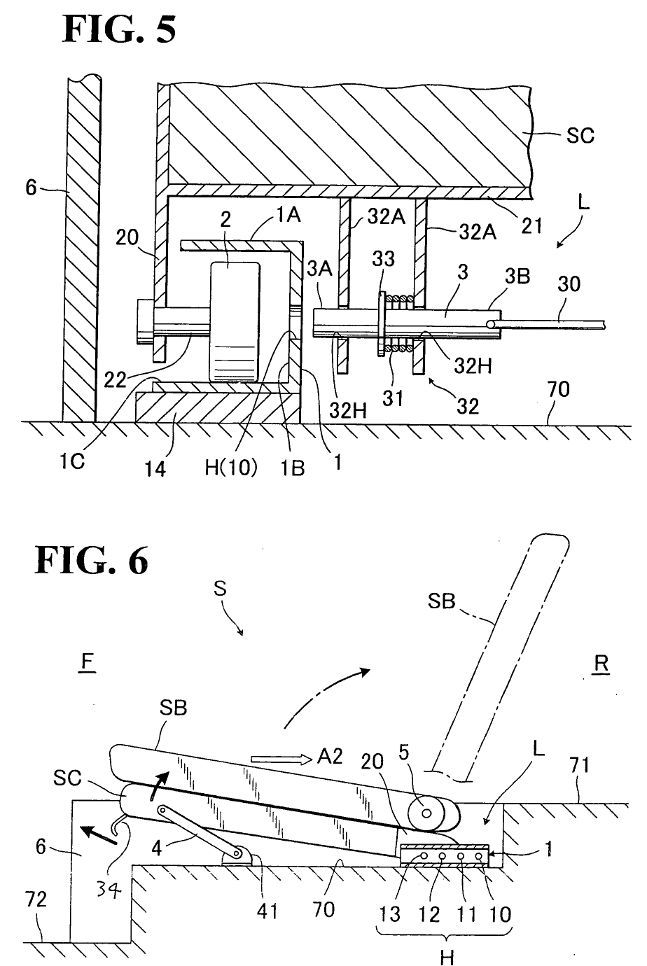

Now, a description will be made of how to use the fold-down seat (S). At first, FIG. 1 shows a state where the seat (S) is locked at a normal seating position and height which is a highest seating level as indicated by (P1). At that position, it is seen that the lock rod (3) is biasingly engaged in the first lock hole (10) under the biasing force of the spring (31), thereby retaining or locking the seat (S) to that normal seating position. When it is desired to fold down the seat (S) from the normal seating position (P1) to a folded-down storage position (at P3 in FIG. 2), a user draws the grip element (34) forwardly with his or her hand to an unlocking direction, as indicated by the arrow, whereupon the lock rod (3) is disengaged from the first lock (10), as shown in FIG. 5, to release the seat (S) from the locked state. Then, as the user draws the seat cushion (SC) forwardly while keeping the grip element (2) to the unlocking direction, the seat cushion (S) is rotated downwardly as indicated by the corresponding arrow, while being simultaneously moved forwardly as indicated by the arrow (A1). As shown in FIG. 2, when the seat (S) moves forwards and reaches the folded-down storage position (P3), the withdrawn lock rod (3) is brought to a point which is coaxially aligned with the fourth lock hole (13), and the seat cushion (SC) may be folded onto the seat mount floor region (70). Further, the seat back (SB) be folded forwardly onto the thus-folded seat cushion (SC). Accordingly, the seat (S) is folded down into such storage state (at P3) as shown in FIG. 2, so that the backward side of the seat back is substantially in registry with the upper surface of the cargo-loading floor region (71), thus providing an extended cargo-loading floor region. Thereafter, the user releases the grip element (34) which is then automatically returned to an unlocking position due to the returning resilient force of the spring (31). Also, due to the biasing force of spring (31), the lock rod (3) is automatically engaged in the fourth lock hole (13), whereby the folded-down seat (S) is locked to the storage position at (P3).

As shown in FIG. 6, if the user wishes to return the seat (S) from the storage position to the normal seating position shown in FIG. 1, he or she should draw the grip element (34) forwardly to disengage the lock rod (3) from the fourth lock hole (13) and continue to push the seat (S) backwardly. Then, the seat cushion (SC) moves backwardly as the guide roller (2) moves along the slide rail (1) in the same backward direction, while being simultaneously raised from the floor region (70) due to the concurrent upward rotation of the link (4) coupled thereto relative to the bracket (41). Finally, when the seat cushion (SC) reaches a normal seating position at (P1), the user releases the grip element (32), with the result that the lock rod (3) is automatically engaged in the first lock hole (10) under the biasing force of spring (31), whereby the seat (S) is locked to the normal seating position at (P1) and then, the seat back (SB) is returned to the normal upright position to completely unfold the seat into a normal seat state shown in FIG. 1.

As appreciated from the foregoing description, the backward end portion of the seat cushion (SC) is slidngily moved via the roller (2) and slide rail (1), while the forward end portion of the same (SC) is guided by the link member (4) downwardly and upwardly, which effectively allows the seat to be easily folded down to a storage position (at P3) by simply drawing the griping element (34) forwardly, or allows the seat to be returned or unfolded to a normal seating position (P1) by simply drawing the grip element (34) forwardly and raising the seat cushion (SC). This indeed reduces a force or labor on the user's side for folding and unfolding the seat and also eliminates the troublesome seat folding steps as found in the prior art.

In addition thereto, it is easily possible to make height adjustment of the seat by simply drawing and releasing the grip element (34) to cause disengagement and engagement of the lock rod (3) from and in a selected one of the plurality of lock holes (H). That is, as understandable from FIG. 4 in conjunction with FIGS. 1 to 3 and 5, when the lock rod (3) is engaged in the first lock hole (10), the seat cushion (SC) is set in the normal seating level or height at (P1), and, for example, when a user releases the grip element (34) to allow the lock rod (3) to biasingly engage in the third lock hole (12), the seat cushion (SC) is set at a seating height (P2) lower than that normal seating height (P1), which thus provides a third seating level. As shown in FIG. 2, when the lock rod (3) is engaged in the fourth hole (13), the seat cushion is set at a lowest level, hence providing a lowest seating height.

Further, it is to be appreciated that, when the seat (S) is locked for seating use, as for example shown in FIG. 1, the seat cushion (SC) is supported by two support points upon the floor region (70); namely, one support point is defined by the link member (4) and another support point is defined by the lock rod (3) and slide rail (1). In other words, a triangular robust structure is established by the upwardly inclined seat cushion (SC) per se, the backwardly inclined link member (4), and the horizontal floor region (70). Hence, such simplified triangular support structure achieves a highly increased strength in attaching the seat cushion (SC) to the floor.

Moreover, the lock holes (H) are directly formed in the slide rail (1) and thus, the lock mechanism (L) is provided to the slide rail (1) in a quite simple manner, thereby adding to structural simplicity of the present fold-down seat.

While having described the present invention so far, it should be understood that the invention is not limited to the illustrated embodiment, but any other modification, replacement, and addition may be applied thereto without departing from the scopes of the appended claims.

What is claimed is:

1. A fold-down seat in combination with a vehicle floor, comprising:
a seat cushion having an upper seating side and a lower side opposite to said upper seating side, wherein said lower side has a forward end portion defined forwardly of the fold-down vehicle seat and a backward end portion defined backwardly of the fold-down vehicle seat;
a seat back rotatably connected with said seat cushion so as to be foldable down on to said upper seating side of the seat cushion;
a link means movably connected between said forward end portion of said bottom side of said seat cushion and said vehicle floor in such a manner as to be movable upwardly and downwardly from and to the vehicle floor;
a slide means operatively provided between said backward end portion of said bottom side of said seat cushion and said vehicle floor, said slide means allowing said seat cushion to be slidingly movable forwardly and backwardly of the fold-down vehicle seat.

2. The fold-down vehicle seat as claimed in claim 1, which further comprises a lock means which is operable to a locking direction so as to place the fold-down vehicle seat in a locked state to a given position and also operable to an unlocking direction so as to place the fold-down vehicle seat in an unlocked state from said given position, wherein said lock means includes a female engagement means and a male engagement means movable for engagement with and disengagement from said female engagement means, wherein said female engagement means is defined in said slide means, while said male engagement means is provided to said lower side of said seat cushion, and wherein locking operation of the lock means to said locking direction causes engagement of said male engagement means with said female engagement means, thereby placing the fold-down vehicle seat in said locked state, while by contrast, unlocking operation of the lock means to said unlocking direction causes disengagement of said male engagement means from said female engagement means, thereby placing the fold-down vehicle seat in said unlocked state.

3. The fold-down vehicle seat according to claim 2, wherein said female engagement means comprises a plurality of lock holes formed in said slide means and said male engagement means comprises a lock rod movably provided to said lower side of said seat cushion so as to be engageable in and disengageable from a selected one of said plurality of lock holes.

4. The fold-down vehicle seat as claimed in claim 1, wherein said slide means comprises: a slide rail means fixed on said vehicle floor; and a roller means rotatably connected with said lower side of said seat cushion, and wherein said roller means is rollably provided in said slide means so as to be slidingly movable therealong.

5. The fold-down vehicle seat according to claim 2, wherein said seat cushion has a forward end defined forwardly of the fold-down vehicle, and wherein said lock means further includes a grip element operatively connected therewith, said grip element being provided to said forward end of said seat cushion, with such an arrangement that, when said grip element is drawn in a forward direction toward a side forwardly of the fold-down vehicle seat, which corresponds to said unlocking direction, said male engagement means is disengaged from said female engagement means, thereby placing the fold-down vehicle seat in said unlocked state, and that, with further drawing of said grip element in the forward direction, said seat cushion is moved and folded toward said vehicle floor through said link means and said slide means.

6. The fold-down vehicle seat according to claim 5, which further comprises a biasing means for giving a biasing force which acts to normally cause engagement of said male engagement means with said female engagement means, and wherein said biasing means is operatively connected with said lock means, such that drawing said grip element in said first direction overcomes said biasing force of said biasing means and thereby causes said disengagement of said male engagement means from said female engagement means, whereas releasing said grip element from the thus-drawn state results in automatic engagement of said male engagement means with said female engagement means due to the biasing force of said biasing means.
